(19) United States
(12) Patent Application Publication
(10) Pub. No.: US 2013/0082106 A1
(43) Pub. Date: Apr. 4, 2013

(54) DOCUMENT READER

(71) Applicants: Masahiro Hoshina, Fukuoka (JP); Jyun Shirahama, Fukuoka (JP)

(72) Inventors: Masahiro Hoshina, Fukuoka (JP); Jyun Shirahama, Fukuoka (JP)

(73) Assignee: PANASONIC CORPORATION, Osaka (JP)

(21) Appl. No.: 13/392,839

(22) PCT Filed: Sep. 29, 2011
(86) PCT No.: PCT/JP2011/005502

§ 371 Date: May 2, 2012

(51) Int. Cl. G06K 7/14

(52) U.S. Cl. 235/455

(57) ABSTRACT

A non-gloss producing compact document reader is provided which solves a problem that when a photo, code information or the like is optically read, illuminating light for taking an image of such information is regularly reflected on a sheet surface, returned to the imaging unit and becomes “gloss” which may prevent the information from being read. A document reader (1) includes an optical mark irradiation unit (21) that radiates an optical mark onto an imaging surface of an imaging target, an imaging unit (22) that takes an image of the imaging surface and an illumination unit (23) that illuminates the imaging surface with illuminating light. When an angle formed between the imaging surface and the imaging unit (22) is an angle at which light (illuminating light regularly reflected on the imaging surface) does not return to the imaging unit, the optical mark has a predetermined shape.

### RELATED APPLICATION

The present application claims a priority based on Japanese Patent Application No. 2010-218171, filed on Sep. 29, 2010, the disclosure of which is incorporated herein by reference in its entirety.

### TECHNICAL FIELD

The present invention relates to a portable document reader, and more particularly, to a technique of precisely reading a document which includes a photo and identification number of an identification card, passport or the like.

### BACKGROUND ART

Conventionally, there are portable document readers such as a document reader that reads photos, characters or the like and performs authentication and a document reader that reads a barcode of a document affixed to a package of a home delivery system, manages circulation and processes a transportation fee using barcode data. Furthermore, desktop readers that optically read passports, driver licenses, identification cards or the like and covert items written therein to data are used at counters of a custom house, air carrier, hotel or the like.

Patent Literature 1 describes a device and method for reading a document affixed with a barcode, capable of reading even a low contrast barcode. To solve a problem that because of low contrast of a printed barcode and appearance of “gloss” by reflection of light on a reading surface, it is difficult to read the printed barcode, this barcode reader provides light sources of red light and white light outside the barcode reader, causes the light sources to emit light simultaneously, and reduces influences of the “gloss” to thereby make it easier to read the barcode (e.g., Patent Literature 1, paragraph 0021, FIG. 3).

### CITATION LIST

### Patent Literature

### [Patent Literature 1] Japanese Patent Laid-Open No. 2007-293798

### SUMMARY OF INVENTION

### Technical Problem

In recent years, systems that read descriptions of a passport using an optical reader, compare the descriptions with a blacklist and thereby identify suspicious individuals and secure safety are being introduced. To protect the described contents and prevent tampering of the descriptions or malicious manipulation such as falsification (replacement of photos or the like), processing such as lamination is often applied to the sheet surface of the passport on which important information such as a photo of the passport, name, date of birth and coded information obtained by coding these items of data is described.

Furthermore, to reinforce the tampering prevention function, printing or drawing may be applied to this laminate itself using a fluorescent material that reacts to specific light.

Applying such lamination certainly produces a tampering prevention effect, but since the surface of a laminate is flatter than the surface of paper, light is likely to be regularly reflected on a surface thereof (“regular reflection” here refers to reflection of light at the same angle of reflection as the angle of incidence upon the laminate surface).

For this reason, when reading coded information such as a photo, name or date of birth, illuminating light for taking an image of such information is regularly reflected on the laminate surface, returned to an imaging unit, converted to “gloss,” which may lead to a problem that it is difficult to read information. Even when there is no laminate, similar “gloss” occurs with information printed on a sheet having a smooth surface such as photogravure paper or photo, which may lead to a problem that it is difficult to read a photo, characters or barcode.

The reading device and method described in Patent Literature 1 places two light sources at places distant from the barcode reader to prevent “gloss”, and therefore the device including the light sources as a whole becomes too large to carry around and the setup including that of the light sources cannot help but take time and trouble. Furthermore, depending on the setup of the light sources, regularly reflected light may return to the imaging unit, increase the possibility that the gloss preventing effect may be insufficient and there still remains a setup-related problem of how to fix the light sources.

The present invention has been implemented to solve the above conventional problems and it is an object of the present invention to provide an excellent document reader including a light source and an imaging unit capable of precisely reading characters, symbols or photo printed on a surface susceptible to regular reflection without being affected by “gloss” and acquiring sufficient information for subsequent processing.

### Solution to Problem

A document reader according to the present invention is a document reader configured to include a mark irradiation unit that irradiates an imaging surface of an imaging target with an optical mark, an imaging unit that takes an image of the imaging surface and an illumination unit that illuminates the imaging surface with illuminating light, wherein the optical mark is configured to have a predetermined shape when an angle formed between the imaging surface and the imaging unit is an angle at which light does not return to the imaging unit, the light being the illuminating light regularly reflected by the imaging surface.

Another aspect of a document reader according to the present invention is a document reader configured to include a mark irradiation unit that irradiates an imaging surface of an imaging target with an optical mark, an imaging unit that takes an image of the imaging surface and an illumination unit that illuminates the imaging surface with illuminating light, wherein the optical mark is configured to have a predetermined shape when an optical axis of the imaging unit and a normal (normal line) of a portion of a center of imaging of the imaging surface form a predetermined imaging angle and the imaging angle is an angle at which light does not return to the imaging unit, the light being the illuminating light regularly reflected by the imaging surface.

Furthermore, the document reader of the present invention has a configuration in which the optical marks indicating opposed both ends of the imaging range become parallel to each other at an imaging angle.

Furthermore, in the document reader of the present invention, the optical marks include a pair of lines indicating opposed both ends of the imaging range of the imaging unit and the pair of lines become parallel to each other at a predetermined imaging angle.

Furthermore, in the document reader of the present invention, the optical mark is a frame-shaped mark indicating the imaging range and the pair of lines of the above optical mark is opposed two sides of the frame-shaped mark.

Furthermore, the document reader of the present invention provides an operation unit on a surface closer to the operator when operating the document reader, provides a holding unit on a back side closer to the operator when operating the document reader, provides a display unit on a surface distant from the operator when operating the document reader, and provides the mark irradiation unit, the imaging unit and the illumination unit on a back side or side distant from the operator when operating the document reader, and the optical mark is radiated onto a position where the operator can visually confirm the display unit and the imaging range.

Furthermore, the document reader of the present invention includes an image correction unit that corrects trapezoidal distortion caused by a predetermined imaging angle.

### Advantageous Effects of Invention

The present invention is intended, when a document reader that irradiates an imaging surface of an imaging target with an optical mark forms an angle at which regularly reflected light does not return from a document or ID card, which is an imaging target, to form the optical mark into a shape such as a rectangle easily recognizable to a user to thereby inform the user that the imaging angle formed by the document reader with respect to the imaging target is a correct one, and can realize a document reader capable of accurately reading an image, characters or graphics or the like without being affected by regular reflection. Thus, the present invention can provide a document reader having an excellent effect of being able to reduce the inconvenience that the user fails to capture an image or the like and has to try to acquire the image or the like again or input numbers or the like corresponding to a code that could not be acquired from a keyboard. Furthermore, the present invention can provide a document reader that will not generate regular reflection even when the light source and the imaging unit are arranged in proximity to each other, and can thereby make the document reader itself small and easy to handle.

As will be described below, the present invention includes other aspects. Therefore, the disclosure of the present invention is intended to provide part of the present invention and not intended to limit the scope of the present invention described and claimed herein.

### BRIEF DESCRIPTION OF DRAWINGS

FIG. 1 is a diagram illustrating an overview of a document reader and a document according to an embodiment of the present invention.

FIG. 2 is a diagram illustrating a configuration of the document reader of the embodiment of the present invention.

FIG. 3 is a diagram illustrating a processing flow of the document reader according to the embodiment of the present invention.

FIG. 4 is a cross-unital view showing the positions of the document reader and the document according to the embodiment of the present invention.

FIG. 5 is a diagram illustrating an example of a first optical mark.

FIG. 6 is a diagram illustrating a change to the first optical mark at an appropriate imaging angle.

FIG. 7 is a diagram illustrating an example of a second optical mark.

FIG. 8 is a diagram illustrating a change to the second optical mark at an appropriate imaging angle.

FIG. 9 is a diagram illustrating an image acquired at an appropriate imaging angle.

FIG. 10 is a diagram illustrating a corrected image.

FIG. 11 is a diagram illustrating a case where an image of a document is taken from right above.

FIG. 12 is a diagram illustrating an acquired image in a case where the image is taken from right above.

FIG. 13 is a schematic view illustrating a case where an image with trapezoidal distortion is reflected in a light-receiving element in the imaging unit.

FIG. 14 is a diagram schematically illustrating an image memory for correcting trapezoidal distortion in the circuit unit.

FIG. 15 is a diagram illustrating a configuration for correcting trapezoidal distortion using a tilt of the optical system.

### DESCRIPTION OF EMBODIMENTS

Hereinafter, the present invention will be described in detail. An embodiment which will be described below is merely an example of the present invention and the present invention can be modified in various modes. Therefore, specific configurations and functions disclosed hereinafter are not intended to limit the scope of claims of the patent.

A document reader according to an embodiment is a document reader configured to include a mark irradiation unit that irradiates an imaging surface of an imaging target with an optical mark, an imaging unit that takes an image of the imaging surface and an illumination unit that illuminates the imaging surface with illuminating light, wherein the optical mark is configured to have a predetermined shape when an angle formed between the imaging surface and the imaging unit is an angle at which light, which is the illuminating light regularly reflected by the imaging surface, does not return to the imaging unit.

With this configuration, the user of the document reader is guided to a relative position between the document reader and the imaging target so that the shape of the optical mark projected by the mark irradiation unit may become a predetermined one.

A document reader according to another embodiment is a document reader configured to include a mark irradiation unit that irradiates an imaging surface of an imaging target with an optical mark, an imaging unit that takes an image of the imaging surface and an illumination unit that illuminates the imaging surface with illuminating light, wherein the optical mark is configured to have a predetermined shape when an optical axis of the imaging unit and a normal of a portion which becomes a center of imaging of the imaging surface form a predetermined imaging angle and the imaging angle is an angle at which light, which is the illuminating light regularly reflected by the imaging surface, does not return to the imaging unit.

With this configuration, the user of the document reader is guided to a relative position between the document reader and the imaging target so that the shape of the optical mark projected by the mark irradiation unit may become a predetermined one.

Furthermore, the document reader according to the embodiment is configured such that the optical mark includes a pair of lines indicating opposed both ends of the imaging range of the imaging unit and the pair of lines become parallel to each other at a predetermined imaging angle.

This configuration makes it possible to precisely indicate the imaging range and inform the user that the document reader forms an appropriate angle with respect to the imaging target.

Furthermore, in the document reader according to the embodiment, the optical mark is a frame-shaped mark indicating the imaging range and the pair of lines of the above optical mark is opposed two sides of the frame-shaped mark.

This configuration allows the user to easily recognize, when the optical mark becomes a rectangle easily recognizable to the user, that the document reader forms an appropriate angle with respect to the imaging target.

Furthermore, the document reader according to the embodiment provides an operation unit on a surface closer to the operator when operating the document reader, provides a holding unit on a back side closer to the operator when operating the document reader, provides a display unit on a surface distant from the operator when operating the document reader, and provides the mark irradiation unit, the imaging unit and the illumination unit on a back side or side distant from the operator when operating the document reader, and the optical mark is radiated onto a position where the operator can visually confirm the display unit and the imaging range.

This configuration makes it possible to provide a document reader which is easy to operate and which allows the imaging range to be easily recognized.

Furthermore, the document reader according to the embodiment includes an image correction unit that corrects trapezoidal distortion caused by a predetermined imaging angle.

This configuration makes it possible to more accurately recognize an acquired image, barcodes or characters.

In the document reader according to the embodiment, the image correction unit may optically correct trapezoidal distortion, correct trapezoidal distortion by modifying data acquired by the imaging unit, correct trapezoidal distortion using a tilt of the objective lens of the imaging unit, correct trapezoidal distortion by adding an optical element to the objective surface of the objective lens of the imaging unit or develop data acquired by the imaging unit on a memory and correct trapezoidal distortion according to weights assigned to addresses in the memory.

Hereinafter, a case will be described where a document is read using the document reader according to an embodiment of the present invention. Particularly, a case will be described in the present embodiment where a document of a driver license or passport or the like having a laminated surface on which characters, photo or the like are described will be read.

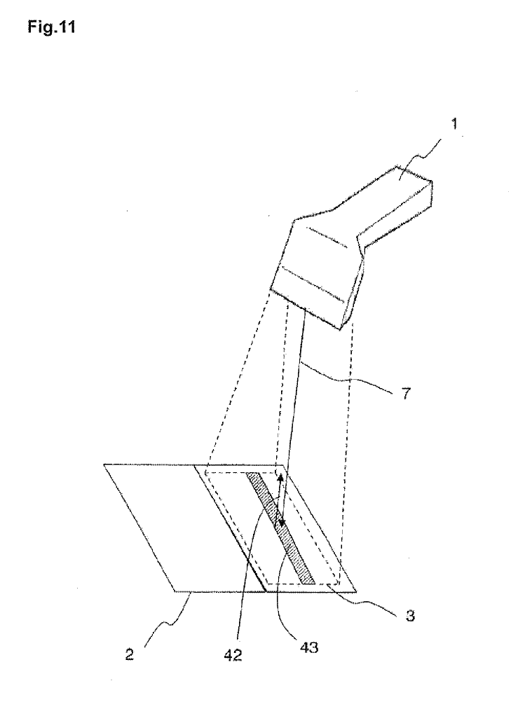

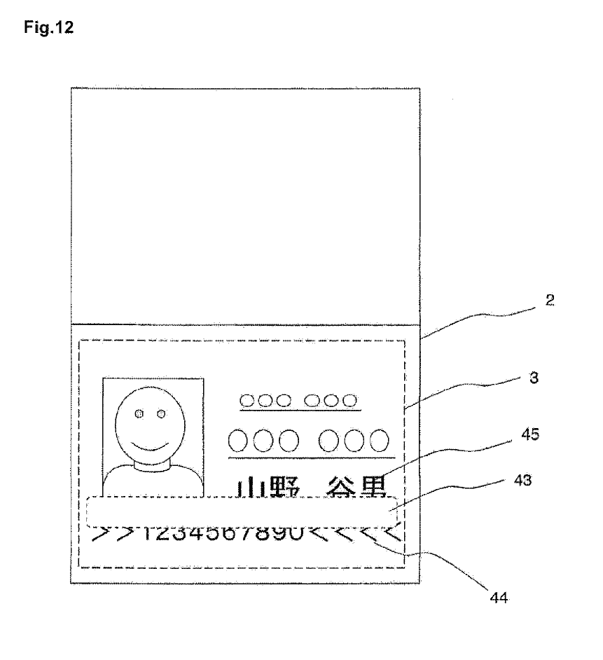

First, conventional problems will be described using FIG. 11 and FIG. 12. FIG. 11 shows a case where an image of a document is taken from right above. An imaging range 3 shown by a broken line on which characters, photo or the like are printed is thoroughly illuminated with illuminating light. A camera which is an imaging unit and a light such as an LED which is an illumination unit are accommodated at a distal end portion of a document reader 1. The illuminating light impinges on the imaging surface at a substantially right angle with respect to the portion of the imaging range right below the illumination unit. This causes a regular reflection region 43 to be generated which is a region where regularly reflected light of the light (reflected light whose angle of reflection is equal to the angle of incidence) impinges on the camera. FIG. 11 schematically shows the light of the illuminating light which is regularly reflected and returned to the imaging unit as illuminating light 7. Furthermore, the light regularly reflected and returned to the imaging unit is schematically shown as regularly reflected light 42. Over-exposure occurs in the portion where the regularly reflected light is returned to the imaging unit, where an image is taken as whitened image, so-called “gloss.” For this reason, it is possible to obtain only an image from which some characters cannot be read as shown in FIG. 12.

FIG. 12 shows an example where part of a name 45 “Tanio Yamano”, part of a code 44 representing the date of birth, sex, date of issue or the like used for data processing cannot be read due to regular reflection.

Accurate data cannot be obtained from such an image even by performing optical reading processing (OCR processing) and a read error occurs. When a read error occurs, the user has to manually enter the name, code or the like of the reading target (“Tanio Yamano” which the name and code 1234567890 in FIG. 12), which would take a lot of time and trouble.

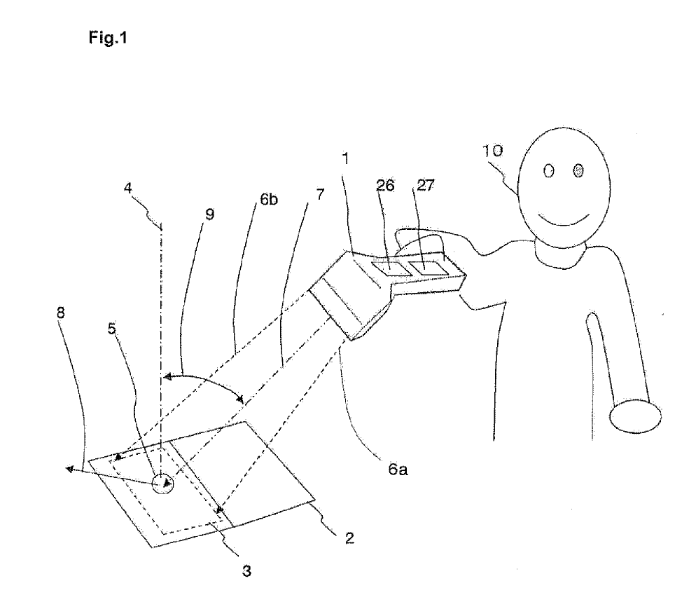

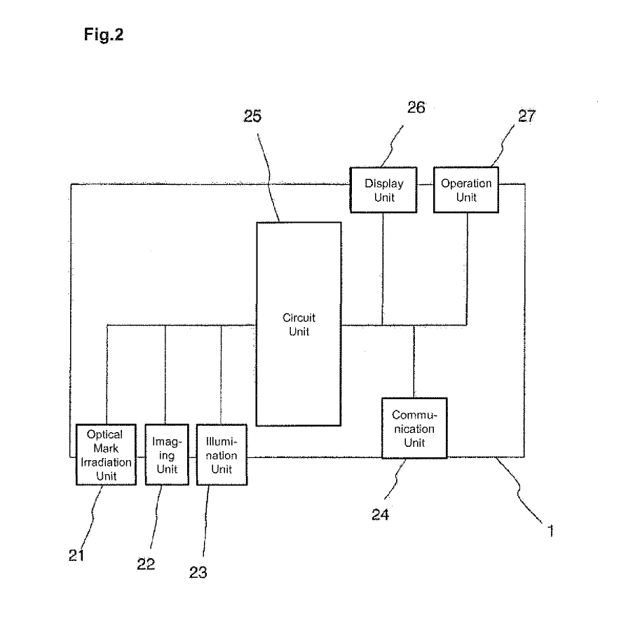

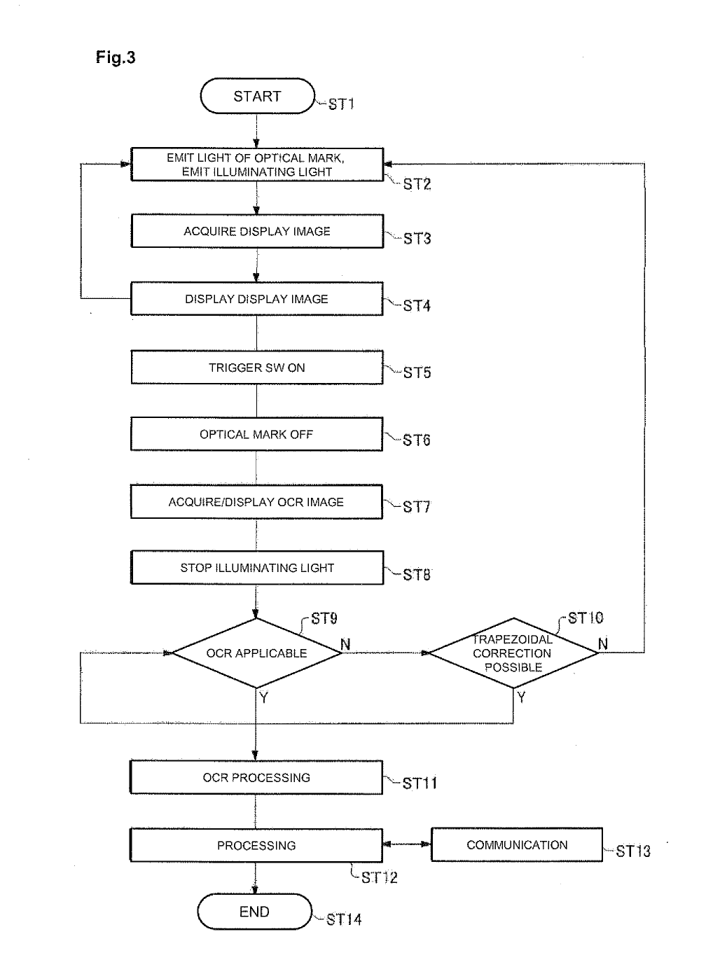

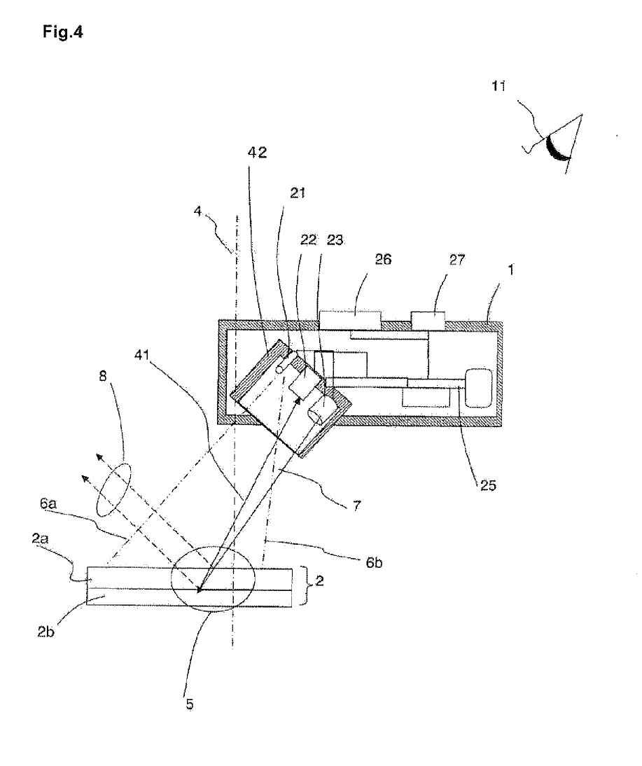

The document reader according to the embodiment of the present invention which solves such a problem will be described with reference to the attached drawings. FIG. 1 is a diagram illustrating an overview of a document reader and a document according to an embodiment of the present invention, FIG. 2 is a diagram illustrating a configuration of the document reader of the embodiment of the present invention, FIG. 3 is a diagram illustrating the processing of the document reader according to the embodiment of the present invention and FIG. 4 is a cross-unital view showing the positional relationship between the document reader and the document.

The document reader 1 of the present embodiment includes an optical reading head unit 42, a display unit 26 and an operation unit 27 arranged in this order. The optical reading head unit 42 includes an optical mark irradiation unit 21, an imaging unit 22 and an illumination unit 23 arranged in proximity to each other as a whole.

First, the positional relationship between a document 2 and the document reader 1 when an image is acquired will be described using FIG. 1 and FIG. 4. An optical mark radiated from the document reader 1 onto the document is radiated as schematically shown by arrows 6a and 6b. The optical mark is radiated so as to indicate the imaging range. Radiation of the optical mark allows the user to recognize the imaging range 3 which is a range within which the image of the document 2 is acquired. Hereinafter, a portion inside the imaging range 3 on the document 2, an image of which is taken by the document reader and on which a photo, name, specific code or the like are printed, which is a particularly important portion, is called an “imaging center” for convenience. The “imaging center” can also be said to be a portion where regular reflection should not occur in particular.

An angle formed between the normal to this imaging center and the optical axis of the imaging unit, the angle being an angle at which illuminating light does not return to the imaging unit is defined as an imaging angle 9. Furthermore, in the following description, when an angle is defined, the “optical axis of the imaging unit” may be simply expressed as an imaging unit. When the imaging unit falls within an imaging angle, the optical mark indicating the imaging range is set so as to indicate an accurate imaging range, but this will be described in detail later.

Furthermore, as the aforementioned imaging center, not only the portion on which a photo, name, specific code are printed are printed but also the center of gravity of the area of the imaging range or a midpoint in the vertical and horizontal directions of the corresponding portion may be used as long as a certain degree of flatness of the document is secured.

The user 10 holds the document reader 1 by hand and takes an image of the imaging range 3 while checking the display unit 26 and the operation unit 27. In this case, the optical mark is used to check the imaging range. The shape of the optical mark indicating the imaging range 3 with trapezoidal distortion caused by the imaging angle 9 added thereto shows an appropriate imaging range on the document and forms a predetermined shape.

Furthermore, although the imaging range is supposed to be a flat surface, the cross unit of the document 2 shown in FIG. 4 may be slightly warped in a convex shape. In such a case, the imaging angle is defined with reference to the normal to the aforementioned “imaging center” and the following description will be given. This is because the imaging center is an area where important information that should necessarily be read is written. The degree of convexity is assumed to fall within a common range expected from a passport, passbook, identification card possessed by a civil servant or the like, but it goes without saying that imaging is possible as long as it is a difference in height in the vertical direction that falls within the depth of field of the camera.

As described above, the angle of incidence is equal to the angle of emergence in regular reflection. The imaging angle 9 is an angle of incidence formed between the virtually shown illuminating light center line 7 and the normal 4 and is a predetermined angle and is set to an angle at which the regularly reflected light from the illumination unit (light) 23 is never returned to the imaging unit (camera) 22 from any place of the imaging region.

A preferable angle for performing imaging may ideally have a margin of on the order of 20%, but it may also be a position of a portion at an end of the imaging range 3 where there is not much information, at which the regularly reflected light is partially returned to the camera, the imaging unit 22. Considering regular reflection alone, the imaging angle 9 is preferably a large angle, which is the safe side, but with a large imaging angle, trapezoidal distortion of an image acquired is also large which may constitute an obstacle to OCR processing. Therefore, it may be preferable to reduce trapezoidal distortion by accepting regular reflection of a portion where there is little information.

Furthermore, operation of the present document reader will be described using FIG. 2, FIG. 3 and FIG. 4. As shown in FIG. 4, the document 2 has a laminate layer 2a on a surface thereof and data is printed on a sheet surface 2b. FIG. 4 shows the sheet 2b and the laminate 2a exaggerated in thickness compared to the actual thickness for explanation. The user 10 aligns the optical mark with the imaging range 3 while visually checking it from a position denoted by reference numeral 11 in FIG. 4.

The document reader 1 includes the optical mark irradiation unit 21, the imaging unit 22, the illumination unit 23, a circuit unit 25 that controls these units, an operation unit 27 whereby the user inputs commands and the display unit 26 that displays an input situation and an acquired image or the like to the user. Furthermore, the document reader is also generally provided with a communication unit 24 that communicates with outside units to perform authentication or the like. The optical mark irradiation unit 21 generally indicates the perimeter of the imaging range 3 or longitudinal lines on both sides or the like of the imaging range 3 using laser light, but may also linearly condense normal light emitted from a light-emitting diode, electric bulb or the like which is not coherent light such as laser light.

The imaging unit 22 is a camera using a sensor such as CCD or CMOS. The circuit unit 25 includes a CPU and a memory, controls the imaging unit 22, optical mark irradiation unit 21, illumination unit 23, display unit 26 or the like via a bus line and each driver circuit and processes inputs from the operation unit 27. The display unit 26 displays the inputs from the operation unit 27 and displays an image acquired by the imaging unit 22 in real time at the time of imaging. An image may be displayed as required.

To be more specific, a case will be described using FIG. 3 and FIG. 4 where the document is a passport and a conductor of an international train that travels across multiple countries is a user who carries the document reader 1.

When the train comes to a region such as a frontier where the passport needs to be checked, the conductor who is the user of the document reader 1 asks a passenger to present the passport, opens the passport and presses a start button provided in the operation unit of the document reader (ST1). The optical mark irradiation unit 21 then radiates the optical mark indicating the imaging range 3. In this case, the illumination unit 23 also emits light simultaneously or alternately with the optical mark and illuminates the imaging range (ST2). At this time, if the temporarily captured display image (ST3) is displayed on the display unit 26 in real time to check the imaging range (ST4), the user can easily confirm the imaging range.

When a photo, name, code or the like are entered in the imaging range 3, the optical mark is formed into a predetermined shape (the predetermined shape will be described later) and the user presses a trigger (button of the operation unit) at the position at which the imaging range is shown (ST5), the image then is taken into the circuit unit 25 by the camera 22 (ST7). The image may be captured at this time by the document reader automatically pressing a shutter based on the focused point of the imaging target and the shape of the optical mark. To perform an automatic capture, the image pickup unit 22 picks up an image of the optical mark as a display image in order for the circuit unit 25 to judge the shape of the optical mark. Next, it is detected through image processing that the longitudinal and lateral lines making up the optical mark form a right angle. Next, since the optical mark is disturbing to OCR processing, the optical mark is switched off and the image is then captured and processing such as OCR is performed.

The same applies to a case where an image is manually captured using a trigger switch, and the presence of the optical mark in the image used for OCR processing is disturbing, and therefore the optical mark is switched off (ST6) immediately after the trigger is switched on (ST5) and immediately before the OCR image is acquired (ST7). Furthermore, after acquiring an OCR image for confirmation, the OCR image is preferably displayed on the display unit 26 for confirmation (ST7). After acquiring the image (OCR image) used for processing (ST12), illumination is stopped (ST8) and character recognition (OCR processing) is performed by the circuit unit 25 (ST11), but it is determined before the processing whether or not OCR processing is applicable to the data (ST9). In the case of the data to which OCR processing is not applicable, the acquired data is subjected to trapezoidal correction for correcting trapezoidal distortion caused by the imaging angle and OCR processing is tried again (ST10).

Here, if the processing is applicable, processing such as confirmation of the expiration date of the passport, checking against a blacklist is performed based on the data obtained through normal OCR processing (ST12). When processing requiring update such as checking against a blacklist is performed, necessary data may be acquired by communicating with an external server via the communication unit 24 (ST13). Furthermore, when OCR processing is not possible even if trapezoidal correction is performed, the process is returned way back to ST2 to acquire an image again. If OCR processing is still not possible even after repeating this loop a predetermined number of times, the processing is considered not applicable and this fact is reported to the user through a display, sound or the like, and a series of operations is finished (ST14).

In such a case, it is then also preferable to display a screen to which contents to be read from the code are input on the display unit 26. Furthermore, since the imaging angle is predetermined, it is also preferable to provide the objective lens of the camera 22 with a tilt correction function to remove trapezoidal distortion from the acquired image itself. As the tilt correction method, it is a general practice to move the image sensor, the objective lens and the optical axis of an imaging target in accordance with the imaging angle, but it is also possible to add another optical system (lens with the center of the lens parallel-translated from the center of the optical axis, wedge-shaped transparent board or the like) outside the objective lens like a conversion lens. In this case, ST10 may be omitted.

Next, a configuration will be described using FIG. 4 in which a description in the document is read while avoiding regularly reflected light from impinging on the imaging unit 22. Light from the illumination unit 23 is schematically shown as light centered on the illuminating light center line 7. Although illuminating light spreads around the illuminating light center line 7 and illuminates the entire imaging range 3, the present embodiment will assume the brightest portion in the central part of the illuminating light as the illuminating light center line 7 that indicates the illuminating light. The illuminating light may be a distribution having a deviation in the periphery of the illuminating light center line 7.

For example, the light path length of light 6a from the optical mark irradiation unit 21 reaching the periphery is greater than that of light 6b in. FIG. 4. Since light spreads, intensity of light decreases at a rate of the square of the light path length. Examples of possible methods of compensating for this problem include a method of increasing intensity of light reaching a distant part to compensate for a difference in illuminance on the plane of the light-receiving element of the imaging unit 22 between sides having long and short distances from the imaging unit 22 within the image pickup range or a method of increasing intensity of light illuminating the coded part to increase the contrast at a portion to which OCR is applied. Although the definition of the illuminating light center line does not change even in such a case, any definition may be adopted as long as it rationally defines an imaging angle which defines an angle at which “illuminating light does not return to the imaging unit,” which is the purport of the present application of the invention, and the illuminating light center need not always be the center of a light quantity distribution.

If the illuminance on the surface of the light-receiving element of the image pickup unit 22 is made to compensate for a difference between sides having long and short distances from the imaging unit 22 within the image pickup range, the distant side in the captured image after image pickup is not darkened, an S/N ratio between the image pickup device and a peripheral circuit thereof becomes substantially constant within the image, brightness correction after imaging is no more necessary and a good, noiseless image can be obtained. Part or the whole of light is reflected on an interface between substances of different refractive indices. However, since described contents of the sheet surface 2b need to be able to be checked, the surface of the laminate 2a should be free of projections and depressions, and have a high degree of flatness. If the surface includes projections and depressions, the sheet surface would become like fogging glass or the description on the sheet surface may be distorted by refraction on projections and depressions.

Thus, since the surface of the laminate and the back side contacting the sheet surface generally have a high degree of flatness, most of reflection on the interface becomes regularly reflected light 8. However, the document reader 1 radiates illuminating light at the imaging angle 9 from the normal to the imaging range (to be exact, this is the normal to the imaging center, but if the imaging range 3 has a flat surface, the direction thereof is substantially the same over the entire imaging range) and takes an image of the passport, and therefore the regularly reflected light 8 travels in a direction opposite to the document reader 1 and does not return to the imaging unit 22.

However, the surface of the sheet surface 2b on which information such as a photo, name or code is printed does not have a degree of flatness as high as that of the surface of the laminate, the illuminating light is reflected diffusely on the sheet surface. Diffused reflection prevents light from being reflected in a specific direction, and therefore part thereof arrives at the imaging unit 22. Thus, the document reader 1 of the invention of the present application can precisely take an image of the description on the sheet surface while preventing regularly reflected light from returning to the imaging unit.

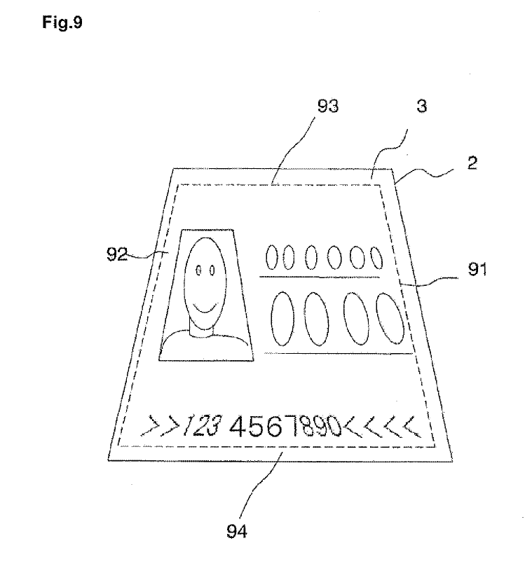

The optical mark indicating the imaging range may assume various modes, but a configuration is easily recognizable to the operator, which basically combines line marks (e.g., light lines indicating both sides 91 and 92 of the document shown in FIG. 9) of light projected onto both sides within the imaging range within which trapezoidal distortion appears prominently and the optical mark which becomes a lateral line orthogonal to the optical mark that forms these longitudinal lines at a regular imaging angle.

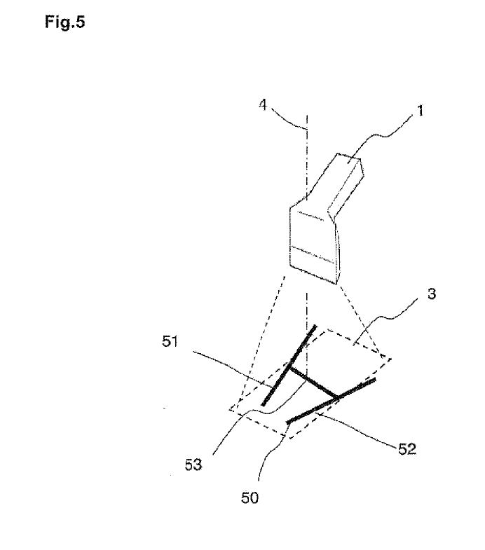

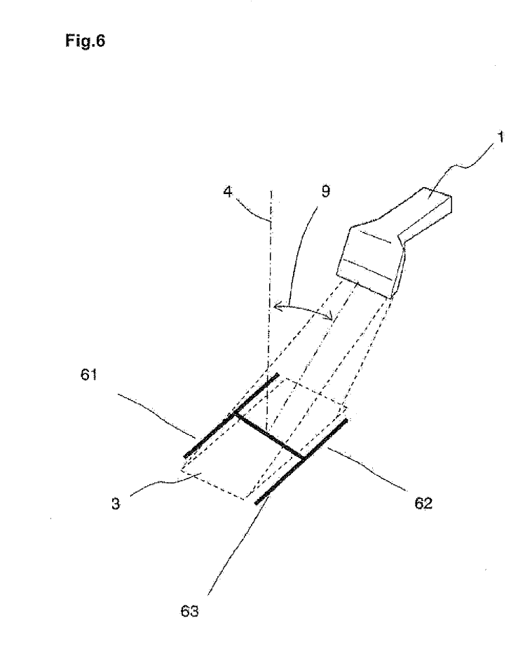

A first mode of the optical mark will be described using FIG. 5 and FIG. 6. This optical mark is intended to indicate the imaging range 3 to the user and made up of line lights 61 and 62 indicating both sides of the imaging range 3 shown by the rectangle in FIG. 5 and FIG. 6, a light line 63 horizontally connecting the central part. For the light source, it is preferable to use a semiconductor laser and create this shape using a diffraction grating, but it is also possible to create this shape using a laser light source and a vibrating mirror. The two-dot dashed lines 6a and 6b shown in FIG. 4 indicate light that reaches the upper part and lower part of the H-shaped optical mark respectively.

As shown in FIG. 5, when the document reader 1 radiates the optical mark right above the imaging range, that is, in a periphery where the imaging angle 9 is close to 0 degrees, a modified H-shaped optical mark 50, which has a narrow-top inverted V shape formed of lines 51 and 52 plus a line 53 connecting the centers of both sides, is drawn on the document. The user gradually tilts the document reader 1 toward the user so that the lateral lines connecting both sides 51 and 52 of the H-shaped optical mark become parallel to each other using the horizontal line 53 as a guideline. With trapezoidal distortion caused by the tilting of the document reader, the distance between the line 51 and line 52 at the top of the inverted V shape gradually opens up, and there is a position where both sides (line 61, line 62) become parallel to each other as shown in FIG. 6.

If this position is set so as to coincide with the imaging angle 9, the user can easily know from the shape of the optical mark 50 that the imaging unit of the document reader and the document together form the imaging angle. It is easy to visually discern that the line 51 and the line 52 are parallel to each other, and further the lateral line 63 connecting both sides and lines 61 and 62 on both sides form a right angle, and since the right angle is easily discernible using the line 63 as a guideline, the user can easily confirm that the imaging angle is an angle at which regular reflection of illumination does not return to the document reader.

After this, the user holds the document reader at the imaging angle, presses the trigger button of the operation unit when the lengths of the lines 51 and 52 of the optical mark on both sides coincide with the imaging range and acquires an OCR image to be used for OCR. Instead of this trigger button, it is also preferable to adopt a configuration in which an OCR image is automatically acquired by detecting a match between a focused point and the length of the optical mark.

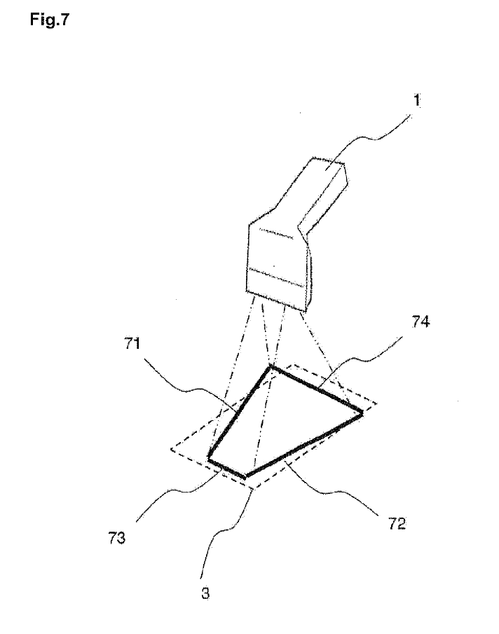

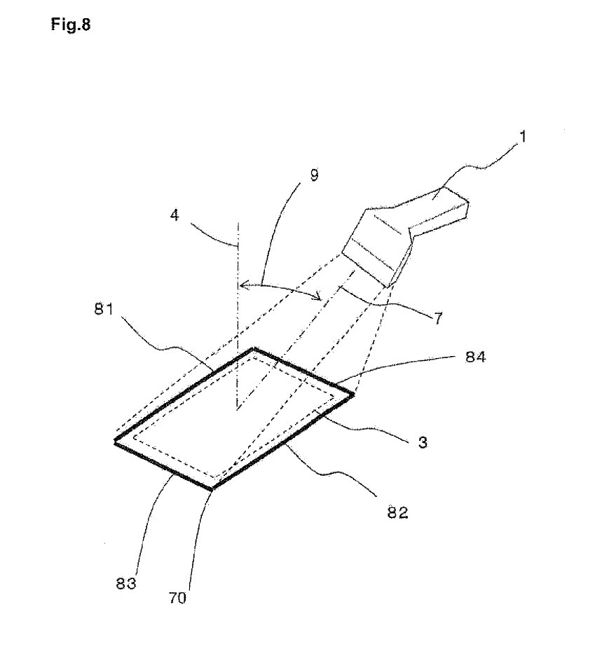

Next, a second mode of the optical mark will be described using FIG. 7 and FIG. 8. An optical mark 80 shown in FIG. 8 forms a rectangle that surrounds the imaging range 3 at the position of an imaging angle. In this case, too, the operation of the document reader from a position at which the angle formed between the imaging unit of the document reader 1 and the normal to the sheet surface is 0 degrees, and a position from which the imaging range is viewed will be described as shown in FIG. 7.

The shape that the optical mark forms at this position is a narrow-top trapezoidal optical mark 70 as shown in FIG. 7. When the document reader 1 is gradually tilted from this condition toward a lower base 74 of the trapezoid while keeping the optical mark surrounding the imaging range 3, longitudinal lines 71 and 72 that the optical mark forms become closer to parallel to each other due to trapezoidal distortion and at the same time an upper base 73 extends.

As shown in FIG. 8, when the imaging unit 22 of the document reader 1 reaches the imaging angle 9, the optical mark 70 changes in shape from a trapezoid to a rectangle due to trapezoidal distortion. Since the rectangular shape is easily distinguishable from the trapezoidal shape, the user adjusts the distance between the document reader and the document while keeping this angle and checking the rectangular optical mark 80 so as to cover the imaging range 3, and can thereby easily perform imaging.

Furthermore, when the imaging range has a square shape, a circle inscribing the square of the imaging range may be adopted as the shape of the optical mark. In this case, when the document reader deviates from a correct imaging angle, the optical mark is deformed into an ellipse, and therefore the user can easily know the correct imaging angle and keep the document reader at the correct imaging angle.

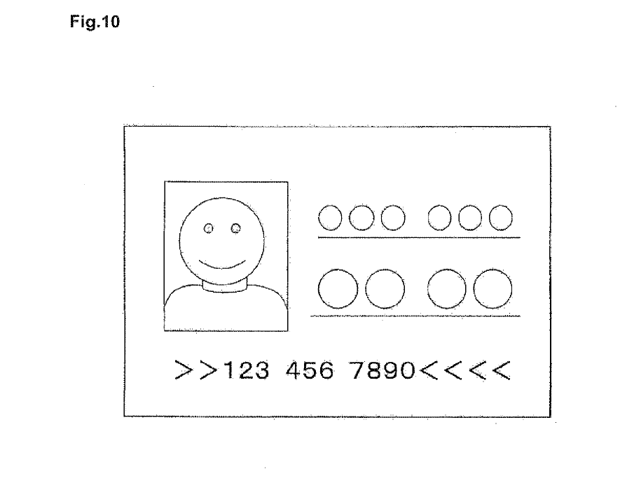

Since images acquired using these methods are images of the document taken at a predetermined imaging angle, the originally desired image shown in FIG. 10 is distorted in a trapezoidal shape as shown in FIG. 9. If OCR has performance highly resistant to distortion of characters, the OCR processing may be continued as is, but when the processing speed needs to be improved or simple processing is preferred, it is preferable to convert the image to one shown in FIG. 10 first and then read the code data.

For this reason, processing of removing trapezoidal distortion from the acquired image may be performed (ST10 in FIG. 3). Examples of the processing method in this case include a method of modifying the acquired image and removing trapezoidal distortion and a method of removing trapezoidal distortion by an optical system itself that acquires an image. The first trapezoidal distortion removing method removes trapezoidal distortion by the circuit unit 25 modifying the acquired image electrically or by software or firmware. This method also includes many methods and all these methods in general modify signals obtained from pixel positions of a camera and remove trapezoidal distortion. In FIG. 9, pixel data near both ends of a top edge 93 of the imaging range 3 is reproduced in a large size, while pixel data in the central part of a bottom edge 94 is reproduced in the same size, and pixel data of other parts is reproduced in a size proportional to the distance between both ends of the top edge 93 and each position, and by reconfiguring and storing all pixel data in this way, it is possible to reproduce a shape similar to that in FIG. 10.

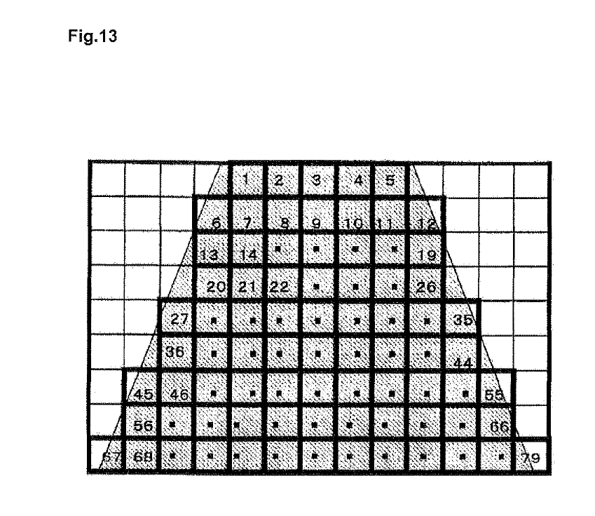

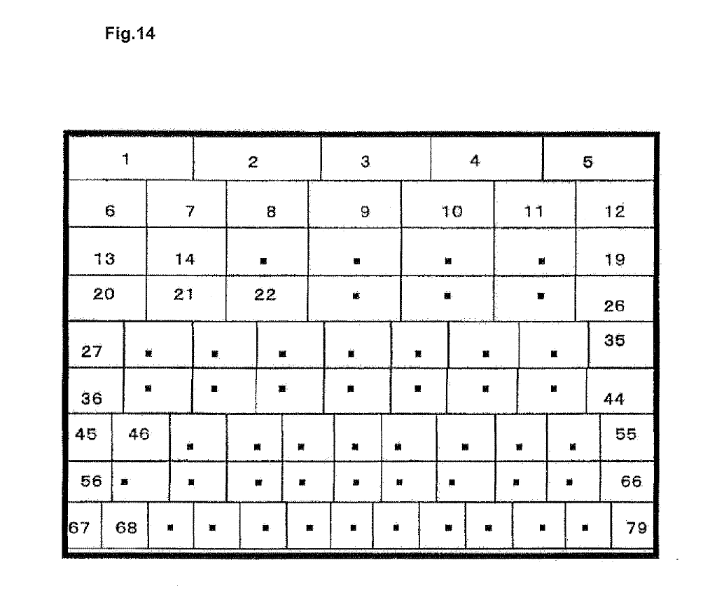

This trapezoidal correction will be described more specifically using FIG. 13 and FIG. 14. FIG. 12 schematically shows a situation in which an image of the document is taken from the position shown in FIG. 1, FIG. 4, FIG. 6 and FIG. 8, and therefore an image deformed into a trapezoidal shape as shown in FIG. 9 is reflected in the light-receiving element of the camera. Elements having on the order of one million to ten million pixels are often actually used for the light-receiving element, but a light-receiving element with 9×13 pixels will be described here for simplicity of explanation. The image of the document 2 passes through the optical system and is projected onto a hatched area in a trapezoidal shape in FIG. 13. The image is projected onto pixel 1 to pixel 5 at the upper base of the trapezoid. The image is sequentially projected in a folding-fan shape from these pixels to pixel 67 to pixel 79 at the lower base of the trapezoid.

To correct this image, a table as shown in FIG. 14 is created in a memory inside the circuit unit 25. Intensities of light projected onto the respective pixels in FIG. 13 are associated with one or a plurality of addresses according to the table in FIG. 14. To be more specific, in the case of FIG. 14, three addresses are associated with pixels 1 to 5 of the light-receiving element, while one address is associated with pixels 67 to 79 of the light-receiving element, and the number of addresses corresponding to the light-receiving element is sequentially reduced from the upper base to the lower base. By converting an image signal obtained at the light-receiving element according to this table, trapezoidal distortion is removed.

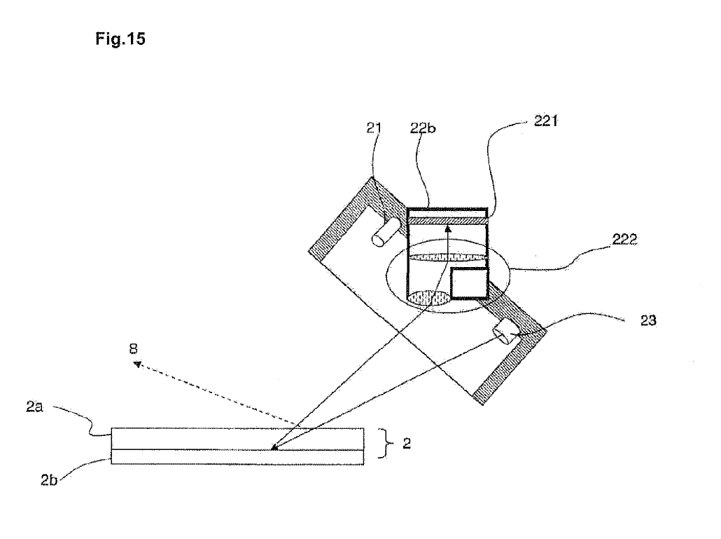

The second trapezoidal distortion removing method incorporates tilt correction in the optical system of the camera beforehand. To perform tilt correction, it is possible to shift the positions of optical parts so as to cancel out trapezoidal distortion generated or incorporate optical elements to cancel out trapezoidal distortion. This trapezoidal correction will be described using FIG. 15, The light-receiving element inside the image pickup unit is arranged so as to be physically parallel to the document 2. In FIG. 15, light from the document 2 passes through a lens 222 and reaches a light-receiving element 221, but since the light-receiving element 221 is tilted by the imaging angle 9 and arranged parallel to the document 2, no trapezoidal distortion occurs on the image of the light-receiving element.

Furthermore, in FIG. 15, the lens 222 is deviated, but it may be possible to adopt a configuration in which the lens and the light-receiving element are arranged parallel to the document so that light diagonally impinging on the lens may be received by part of the light-receiving element. In addition, there are a variety of optical tilt correction methods, and similar effects can be obtained using any one of these methods. Even when such optical tilt correction is performed, trapezoidal correction processing ST10 in FIG. 3 preferably still exists. This is because the hand-held document reader may not be able to accurately keep an angle, and may thereby produce trapezoidal distortion.

Regarding the positional relationship between the document reader and the imaging range, irrespective of whether the document reader itself and the imaging range are parallel or perpendicular to each other, the present invention holds true as long as the positional relationship between the optical mark irradiation unit, illuminating light, camera and imaging range is as described above.

The document reader 1 according to the embodiment of the present invention prevents regularly reflected light of illumination from returning to the imaging unit, presents an appropriate imaging angle whose trapezoidal distortion falls within an allowable range using an optical mark in a manner easy to understand to the user, and can thereby realize a document reader capable of preventing generation of “gloss” which is an over-exposed portion due to regular reflection, reducing insufficient reading and accurately reading images, characters, graphics or the like.

Even when the imaging unit and the illumination unit are arranged in proximity to each other, regularly reflected light is prevented from entering the imaging unit and it is thereby possible to provide a document reader with a compact and easy to handle optical reading unit.

Furthermore, it is possible to reduce the inconvenience of the configuration described so far that the user fails to read an image or the like, has to retry acquiring an image or the like or input numbers or the like corresponding to a code that cannot be acquired from a keyboard. Furthermore, by performing trapezoidal correction corresponding to an imaging angle predetermined in the acquired image, it is possible to realize OCR processing in an accurate shape and thereby improve reading accuracy during OCR.

The preferred embodiment of the present invention conceivable at the present time has been described above, but a variety of modifications can be made to the present embodiment and the attached scope of claims is intended to include all such modifications without departing from the true spirit and scope of the present invention.

### INDUSTRIAL APPLICABILITY

As described so far, the document reader according to the present invention radiates an optical mark indicating an imaging range onto an imaging surface of an imaging target, guides the user to the position of the document reader at an angle at which regularly reflected light from the imaging target is not returned, and can thereby accurately read images, characters, graphics or the like without being affected by regular reflection from the reading target.

Thus, the present invention is useful because the present invention can reduce the inconvenience that the user fails to capture an image or the like, has to retry acquiring the image or the like or input numbers or the like corresponding to a code from the keyboard, and also reduce the size of the apparatus and produce an excellent effect of providing a document reader with excellent handling and portability.

### REFERENCE SIGNS LIST

1 Document reader
2 Document
2a Laminate layer
3 Imaging range
4 Normal
5 Imaging center
21 Optical mark irradiation unit
22 Imaging unit
23 Illumination unit
25 Circuit unit
26 Display unit
27 Operation unit
43 Regular reflection region
50, 70, 80 Optical mark

1. A document reader comprising:
a mark irradiation unit that irradiates an imaging surface of an imaging target with an optical mark;
an imaging unit that takes an image of the imaging surface; and
an illumination unit that illuminates the imaging surface with illuminating light,
wherein the optical mark is configured to have a predetermined shape when an angle formed between the imaging surface and the imaging unit is an angle at which light does not return of the imaging unit, the light being the illuminating light regularly reflected by the imaging surface.

2. A document reader, comprising:
a mark irradiation unit that irradiates an imaging surface of an imaging target with an optical mark;
an imaging unit that takes an image of the imaging surface; and
an illumination unit that illuminates the imaging surface with illuminating light,
wherein the optical mark is configured to have a predetermined shape when an optical axis of the imaging unit and a normal of a portion of a center of imaging of the imaging surface form a predetermined imaging angle, and the imaging angle is an angle at which light does not return to the imaging unit, the light being the illuminating light regularly reflected by the imaging surface.

3. The document reader according to claim 1, wherein the optical mark comprises a pair of lines indicating opposed both ends of the imaging range of the imaging unit and the pair of lines become parallel to each other at the predetermined imaging angle.

4. The document reader according to claim 3, wherein the optical mark is a frame-shaped mark indicating the imaging range, and the pair of lines of the optical mark is opposed two sides of the frame-shaped mark.

5. The document reader according to claim 1, wherein the document reader provides:
an operation unit on a surface closer to the operator when operating the document reader;
a holding unit on a back side closer to the operator when operating the document reader;
a display unit on a surface distant from the operator when operating the document reader; and
the mark irradiation unit, the imaging unit and the illumination unit on a back side or side distant from the operator when operating the document reader, and
the optical mark is radiated onto a position where the operator can visually confirm the display unit and the imaging range.

6. The document reader according to claim 1, further comprising an image correction unit that corrects trapezoidal distortion caused by the predetermined imaging angle.

7. The document reader according to claim 6, wherein the image correction unit optically corrects trapezoidal distortion.

8. The document reader according to claim 6, wherein the image correction unit corrects trapezoidal distortion by modifying data acquired by the imaging unit.

9. The document reader according to claim 7, wherein the image correction unit corrects trapezoidal distortion by tilting of an objective lens of the imaging unit.

10. The document reader according to claim 7, wherein the image correction unit corrects trapezoidal distortion by adding an optical element to an objective surface of an objective lens of the imaging unit.

11. The document reader according to claim 8, wherein the image correction unit develops data acquired by the imaging unit on a memory and corrects trapezoidal distortion according to weights assigned to addresses in the memory.
